(19) United States
(12) Patent Application Publication
(10) Pub. No.: US 2017/0136815 A1
(43) Pub. Date: May 18, 2017

(54) DRIVER KEYS FOR USE WITH WHEEL RIMS

(71) Applicant: Caterpillar Inc., Peoria, IL (US)

(72) Inventor: Paul M. Cavanaugh, Aurora, IL (US)

(73) Assignee: Caterpillar Inc., Peoria, IL (US)

(21) Appl. No.: 14/941,834

(22) Filed: Nov. 16, 2015

(51) Int. Cl. B60B 25/14; B60B 25/10; B60B 25/00

(52) U.S. Cl. CPC B60B 25/14; B60B 25/004; B60B 25/10; B60B 2320/14; B60B 2900/325; B60B 2900/5116

(57) ABSTRACT

A driver key is provided for coupling a rim base and a bead seat band of a wheel rim assembly together. The driver key includes a body having a first engagement surface and a second engagement surface. The first and second engagement surfaces are each oriented at an angle of less than ninety degrees relative to a longitudinal axis of the body.

### TECHNICAL FIELD

The present disclosure generally relates to driver keys, and more particularly to driver keys, and related driver key assemblies, for use with wheel rims.

### BACKGROUND

This section provides background information related to the present disclosure which is not necessarily prior art.

Multi-piece wheel rims are used to install tires to vehicles. Typically, the rims are used on vehicles with relatively large tires having structurally reinforced beads that are not sufficiently deformable to slide over side flanges of the rims. As a result, the rims are usually formed of multiple pieces, for example, three pieces or five pieces, to facilitate mounting the tires on the rims and removing the tires from the rims. Often, when vehicles having such rims rapidly accelerate or decelerate, the tires resist spinning with respect to the ground while the rims are responding to drive trains of the vehicles attempting to rotate the tires. This can result in relative movement between the rims and the tires. More particularly, frictional engagement between side flanges of the rims and the tires causes the side flanges to move in unison with the tires while rim bases move in response to the drive trains, either faster or slower than the tires. As a result, the rim bases may move relative to the side flanges, which, in turn, may cause parts of the rims to separate and/or allow air to leak between parts of the rims.

Driver keys are often attached to the rims via pockets to help secure the side flanges of the rims to the rim bases, to inhibit the relative circumferential movement between the rim bases and the side flanges (and tires). However, conventional driver keys have cross-shaped configurations that produce focused concentrations of forces and high contact pressures at the driver keys during operation of the vehicles, which may cause the driver keys to move within the pockets. This movement can result in misalignment of the driver keys in the pockets and, in some cases, deformation of the driver keys and/or the rims.

U.S. Pat. No. 5,107,914 (Yamoto, et al.), titled “Driving Mechanism for a Multi-Piece Rim,” discloses a driving mechanism for a five-piece wheel rim used in industrial vehicles. The five-piece rim includes a rim base on which a tire is mounted, a bead seat band attached about a periphery of the rim base, a pair of side rings for holding the tire on the rim base, and a lock ring for locking the bead seat band on the rim base. The driving mechanism connects to the rim base and the bead seat band, to secure the bead seat band to the rim base. The driving mechanism defines a conventional cross-shaped key having a rectangular body with uniform thickness and a pair of arms. The arms are oriented at right angles relative to the body (i.e., the arms define interior angles of ninety degrees relative to the body of the key) and extend, in opposite directions, longitudinally away from the body. When the key is positioned in pockets on the bead seat band and rim base, the arms of the key are located in grooves defined between the rim base and the bead seat band.

### SUMMARY

This section provides a general summary of the disclosure, and is not a comprehensive disclosure of its full scope or all of its features.

In one aspect, the present disclosure provides a driver key for coupling a rim base and a bead seat band of a wheel rim together. The driver key generally includes a body having a first engagement surface and a second engagement surface. The first and second engagement surfaces are each oriented at an angle of less than ninety degrees relative to a longitudinal axis of the body.

In another aspect, the present disclosure provides a method generally including providing a driver key for coupling a rim base and a bead seat band of a wheel rim together. The driver key includes first and second engagement portions on a body of the driver key, where the first and second engagement portions are each oriented at an angle of less than ninety degrees relative to a longitudinal axis of the body.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a side view of an exemplary wheel rim assembly of the present disclosure;

FIG. 2 is an enlarged fragmentary view of the wheel rim assembly of FIG. 1;

FIG. 3 is a perspective view of an exemplary driver key assembly of the present disclosure, as associated with the wheel rim assembly of FIG. 1;

FIG. 4 is an exploded view of the driver key assembly of FIG. 3;

FIG. 5 is a side view of a driver key of the driver key assembly of FIG. 3;

FIG. 6 is a view of a pocket of the driver key assembly of FIG. 3;

FIG. 7 is a sectional view of another pocket of the driver key assembly of FIG. 3;

FIGS. 8 and 9 are opposite end views of the driver key of FIG. 5; and

FIG. 10 is another side view of the driver key of the driver key assembly of FIG. 3.

Corresponding reference numerals indicate corresponding parts throughout the several views of the drawings.

### DETAILED DESCRIPTION

The present disclosure generally relates to driver keys, and more particularly to driver keys, and related driver key assemblies, for use with wheel rims, and related methods. Exemplary embodiments thereof will now be described more fully with reference to the accompanying drawings.

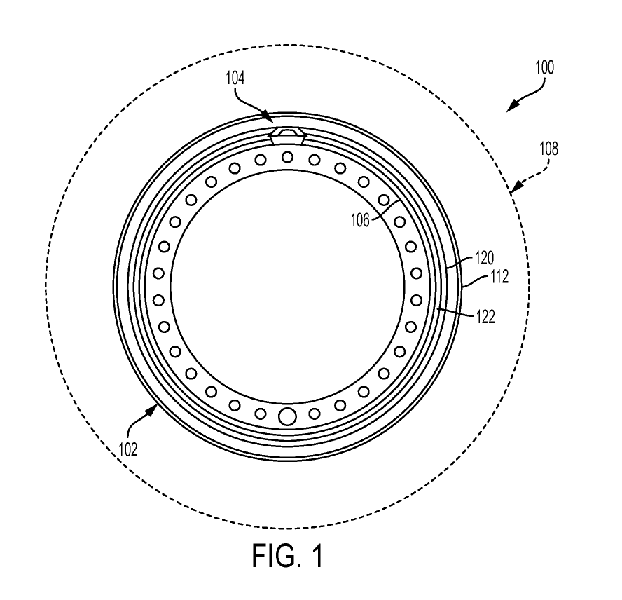

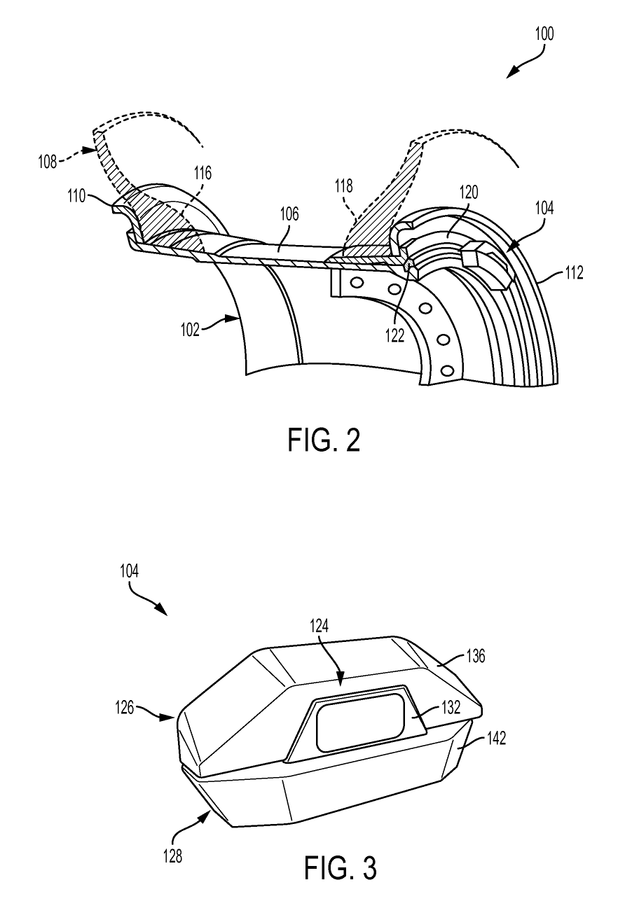

FIGS. 1 and 2 illustrate an exemplary wheel rim assembly 100. The wheel rim assembly 100 includes a wheel rim 102 and a driver key assembly 104. The wheel rim 102 includes a rim base 106 on which a tire 108 is mounted, and flanges 110, 112 holding the tire 108 on the rim base 106. The flanges 110, 112 define bead seats that receive tire beads 116, 118, respectively, of the tire 108 and help secure the tire 108 on the rim base 106. The wheel rim 102 also includes a bead seat band 120 positioned about a periphery of the rim base 106, generally along flange 112, and a lock ring 122 positioned between the rim base 106 and the bead seat band 120. The lock ring 122 holds the flange 112 and the bead seat band 120 on the rim base 106 under pressure of the tire 108 when the tire 108 is inflated. In various embodiments, a seal (e.g., an O-ring, etc.) may also be provided between the bead seat band 120 and the rim base 106 to help retain air (or other fluid) in the inflated tire 108. In this manner, the inflated tire 108 may be retained on the wheel rim 102 for use on a vehicle.

The wheel rim 102 is illustrated as a five-piece rim. However, the present disclosure is not limited to such a rim, as the driver key assembly 104 may also be used with other multi-piece rims. For example, the driver key assembly 104 may be used with three-piece rims, comprising rim bases, bead seat bands, and lock rings, or with other five-piece rims, or even with other multi-piece rims (e.g., rims that are modified versions of three-piece rims and/or five-piece rims, etc.). As such, the driver key assembly 104 should not be considered limited to the particular wheel rim 102 illustrated in FIGS. 1 and 2, or to a five-piece rim in general. Further, the various components of the illustrated wheel rim 102 should not be considered required features or parts of all wheel rim assemblies herein, or of the driver key assembly 104, or of driver key 124 thereof.

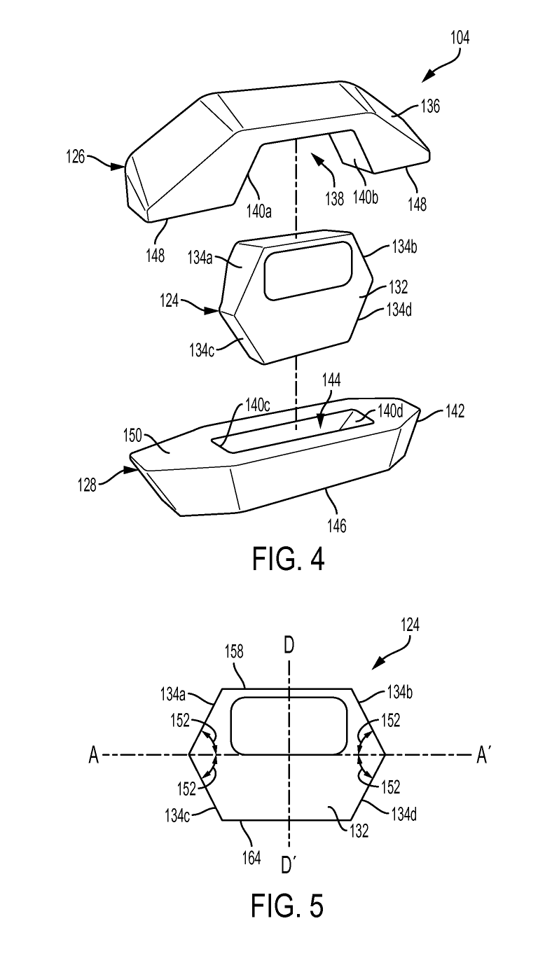

With reference to FIGS. 3 and 4, the driver key assembly 104 includes the driver key 124, and upper and lower pockets 126, 128 (as viewed in FIGS. 3 and 4). The driver key 124 includes a body 132 defining multiple engagement surfaces 134a-d (broadly, engagement portions) around a periphery of the body 132. The upper pocket 126 includes a body 136 defining a channel 138 and contact surfaces 140a-b (broadly, contact portions) on the body 136 along a periphery of the channel 138. The lower pocket 128 includes a body 142 defining an opening 144 and additional contact surfaces 140c-d (broadly, contact portions) on the body 142 along a periphery of the opening 144. In the illustrated embodiment, the opening 144 of the lower pocket 128 does not extend completely through a base 146 of the pocket 128 (also see FIG. 7). However, such a construction is not required as, in other embodiments, the opening 144 may extend through the base 146 of the lower pocket 128.

The upper and lower pockets 126, 128 of the driver key assembly 104 are configured to couple, respectively, to the bead seat band 120 and the rim base 106 of the wheel rim 102 (as shown in FIGS. 1 and 2). Any suitable fastening means may be used to accomplish the coupling, including, for example, welds, nuts and bolts, etc. In addition, when coupled to the bead seat band 120 and the rim base 106, a face portion 148 of the upper pocket 126 is adjacent a face portion 150 of the lower pocket 128 (as shown in FIGS. 1-3). In some embodiments, the face portion 148 may be in contact with the face portion 150. The body 132 of the driver key 124 then fits between the pockets 126, 128, with an upper portion of the body 132 disposed within the channel 138 of the upper pocket 126 and a lower portion of the body 132 disposed within the opening 144 of the lower pocket 128.

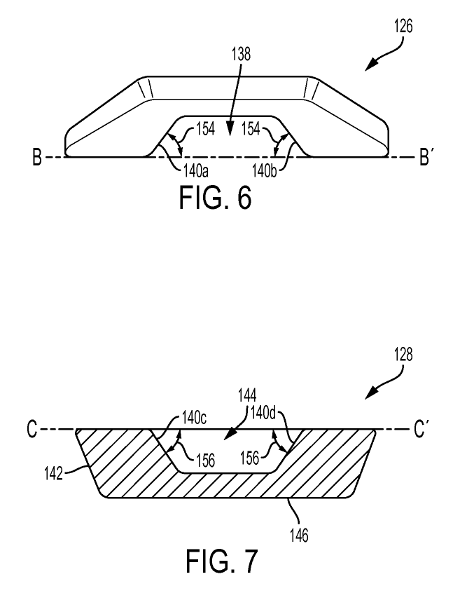

With additional reference to FIGS. 5-7, the engagement surfaces 134a-d of the driver key 124 are each oriented at an angle 152 relative to a longitudinal axis A-A′ of the driver key 124 (FIG. 5) (e.g., about thirty degrees, about forty-five degrees, about fifty-five degrees, about sixty degrees, about sixty-five degrees, about seventy degrees, about eighty degrees, discrete angles therebetween, etc.). Similarly, the contact surfaces 140a-b of the upper pocket 126 are each oriented at an angle 154 relative to a longitudinal axis B-B′ of the upper pocket 126 (FIG. 6) (e.g., about thirty degrees, about forty-five degrees, about fifty-five degrees, about sixty degrees, about sixty-five degrees, about seventy degrees, about eighty degrees, discrete angles therebetween, etc.). And, the contact surfaces 140c-d of the lower pocket 128 are each oriented at an angle 156 relative to a longitudinal axis C-C′ of the lower pocket 128 (FIG. 7) (e.g., about thirty degrees, about forty-five degrees, about fifty-five degrees, about sixty degrees, about sixty-five degrees, about seventy degrees, about eighty degrees, discrete angles therebetween, etc.). The angle 152 defined by each of the engagement surfaces 134a-d is less than ninety degrees. The angles 154, 156 defined by each of the corresponding contact surfaces 140a-d are also less than ninety degrees, and complement (e.g., generally match, etc.) the angle 152 of the engagement surfaces 134a-d. While, in the illustrated embodiment, the engagement surfaces 134a-d of the driver key 124 are each oriented at the same angle 152, it should be appreciated that one or more of the engagement surfaces 134a-d may define different angles in other embodiments. In addition, it should be appreciated that the contact surfaces 140a-d of the pockets 126, 128 may also define different angles in other embodiments, and that the angles may or may not match the angle(s) of the respective engagement surfaces 134a-d. However, in such other embodiments, the angles 152, 154, 156 of the engagement surfaces 134a-d and/or the contact surfaces 140a-d may still be less than ninety degrees relative to the corresponding axes A-A′, B-B′, C-C′ of the respective driver key 124 and pockets 126, 128.

As shown in FIG. 5, the illustrated driver key 124 is free of features, such as arms or other projections, extending away from the body 132 of the driver key 124, for example, in a direction along the longitudinal axis A-A′ of the driver key 124 or along axis D-D′ of the driver key 124 (or in directions therebetween). In particular, the driver key 124 does not include features extending away from the engagement surfaces 134a-d, for example, at right angles or perpendicular to the engagement surfaces 134a-d, or features extending away from the driver key 124 at locations between the engagement surfaces 134a-d. With this construction, the driver key 124 (and its body 132) can also be viewed as free of interior angles. In other words, the driver key 124 does not include angles located interior of (or interior to) outer-most edge portions of the body 132 of the driver key 124, or angles recessed inwardly of the driver key body 132. As an example, in conventional cross-shaped driver keys, interior angles are defined between arms (or other features) extending longitudinally away from the driver keys, and bodies of the driver keys. Such interior angles are recessed inwardly of the bodies of the driver keys and are located interior of (or interior to) outer-most edge portions of the bodies of the driver keys. In the illustrated embodiment, the driver key 124 does not include any such features extending away from the body 132 that would create interior angles with the body 132.

When the driver key 124 is at least partially disposed (and provided) in the upper and lower pockets 126, 128 of the driver key assembly 104 (as illustrated in FIGS. 1-3), the engagement surfaces 134a-d of the driver key 124 are adjacent the respective contact surfaces 140a-d of the pockets 126, 128. In addition, because the angle 152 of the engagement surfaces 134a-d complements the angles 154, 156 of the contact surfaces 140a-d, the engagement surfaces 134a-d also align (e.g., are in face-to-face arrangement, are generally parallel, etc.) with the respective contact surfaces 140a-d. For example, at least half of a surface area of each of the engagement surfaces 134a-d of the driver key 124 may align in face-to-face arrangement with the respective contact surfaces 140a-d of the pockets 126, 128. And, in at least some embodiments, substantially all (e.g., about 100 percent, etc.) of a surface area of each of the engagement surfaces 134a-d may align in face-to-face arrangement with the respective contact surfaces 140a-d. Further, because the driver key 124 is free of arms or other features extending away from the body 132, and is also free of interior angles, the driver key 124 is generally contained within the channel 138 and the opening 144 of the respective pockets 126, 128. In this embodiment, the driver key 124 does not include any features extending away from the body 132 beyond the channel 138 and/or the opening 144 between the face portions 148, 150 of the pockets 126, 128 (e.g., into a space between the bead seat band 120 and the rim base 106 of the wheel rim 102, as in conventional driver keys; etc.).

In the illustrated embodiment, the body 132 of the driver key 124 defines an elongated hexagon shape. In addition, the body 132 is symmetrical about the longitudinal axis A-A′, such that the engagement surface 134a is generally parallel to the engagement surface 134d and the engagement surface 134b is generally parallel to the engagement surface 134c. In other embodiments, however, the driver key 124 may have other shapes. For example, the driver key 124 may have a heptagon shape, an octagon shape, a shape that is not symmetrical, etc. But again, in such embodiments, the body 132 of the driver key 124 may still remain free of interior angles and/or arms.

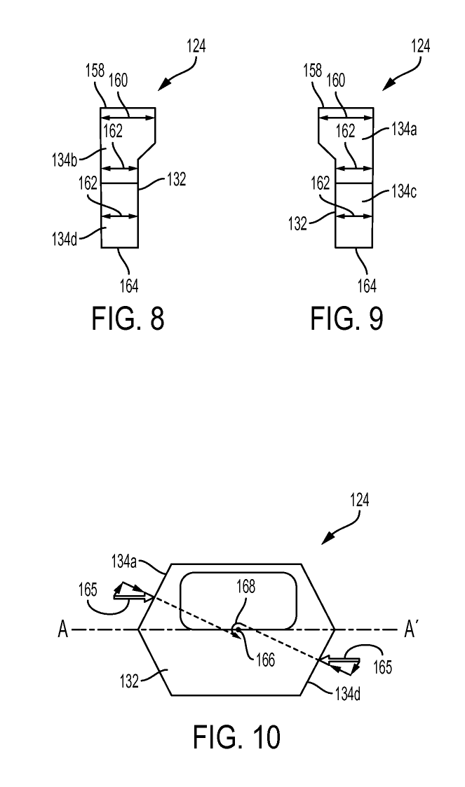

With reference now to FIGS. 8 and 9, the upper portion of the body 132 of the driver key 124 is thicker than the lower portion, in a direction transverse to the longitudinal axis A-A′ (and to the axis D-D′) of the driver key 124. In addition, upper portions of the engagement surfaces 134a-b of the driver key 124 are also thicker than lower portions of the same engagement surfaces 134a-b. Further, the upper portions of the engagement surfaces 134a-b are thicker than the engagement surfaces 134c-d, which are about the same thickness as the lower portions of the engagement surfaces 134a-b. As such, the driver key 124 can be viewed as having a variable thickness, along the axis D-D′, between the upper and lower portions of the driver key body 132. In particular, an upper surface 158 of the body 132 includes a thickness defined by thickness dimension 160. Similarly, upper portions of the engagement surfaces 134a-b both include a thickness that is the same as thickness dimension 160. Lower portions of the engagement surfaces 134a-b both include a thickness defined by thickness dimension 162, as does lower surface 164 of the body 132. And, the engagement surfaces 134c-d both include a thickness that is the same as thickness dimension 162. The thickness dimension 160 is greater than the thickness dimension 162. It should be appreciated that the engagement surfaces 134a-d may have any suitable thickness dimensions 160, 162 within the scope of the present disclosure, for example, with the thickness dimension 160 greater than the thickness dimension 162.

Finally, the driver key 124 and the upper and lower pockets 126, 128 of the driver key assembly 104 (and their associated features) may each be formed using suitable processes and materials. For example, suitable forging processes using steel, alloys, etc. may be used, as well as suitable milling processes, molding processes, etc. In connection therewith, a method of providing the driver key 124 may include forming the driver key 124 with the engagement surfaces 134a-d each oriented at the angle 152 relative to the longitudinal axis A-A′ of the driver key 124, with the body 132 free of interior angles and free of arms extending away from the body 132, and/or with the body 132 having a variable thickness along axis D-D′ of the driver key 124. Similarly, a method of providing the pockets 126, 128 may include forming the pockets 126, 128 with the contact surfaces 140a-b and 140c-d at the angles 154, 156 that complement the angle 152 of each of the engagement surfaces 134a-d. Either or both of the methods may then further include providing (e.g., coupling, etc.) the pockets 126, 128 on the bead seat band 120 and the rim base 106 of the wheel rim 102, and/or providing (e.g., positioning, etc.) the driver key 124 at least partly within the pockets 126, 128.

### INDUSTRIAL APPLICABILITY

As shown in FIGS. 1 and 2, the driver key 124, and the corresponding driver key assembly 104, can be included in (or associated with) the wheel rim 102, which is used for mounting the tire 108 on a vehicle (not shown). The vehicle may include any desired vehicle within the scope of the present disclosure such as, for example (and without limitation), off-highway vehicles designed to be driven on unpaved terrains, etc. The upper pocket 126 of the driver key assembly 104 can couple to the bead seat band 120 of the wheel rim 102, and the lower pocket 128 of the driver key assembly 104 can couple to the rim base 106. The driver key 124 can then be positioned within the pockets 126, 128. In this manner, the driver key assembly 104 is provided to secure the bead seat band 120 and the rim base 106 together. In so doing, the driver key 124 (and the driver key assembly 104) may inhibit circumferential slipping movement between the bead seat band 120 (and tire 108) and the rim base 106 of the wheel rim 102.

In use, when the vehicle moves and causes the wheel rim 102 to rotate, depending on a direction of such rotation, engagement surfaces 134a-d of the driver key 124 move into contact with corresponding ones of the contact surfaces 140a-d of the pockets 126, 128. For example, when the wheel rim 102 rotates counter-clockwise (as viewed in FIG. 1), the engagement surfaces 134a, 134d of the driver key 124 contact the contact surfaces 140a, 140d, respectively, of the pockets 126, 128. Because the angle 152 of each of the engagement surfaces 134a, 134d complements the angles 154, 156 of the respective contact surfaces 140a, 140d, the contact may be a mating, face-to-face contact. In addition, because the engagement surfaces 134a, 134d are oriented at the angle 152 of less than ninety degrees, they may be longer (and larger in surface area) than in conventional driver keys. Therefore, forces from the bead seat band 120 and the rim base 106 (as received through the contact surfaces 140a, 140d of the pockets 126, 128) may be imparted across the entire surface area of the longer (and larger) engagement surfaces 134a, 134d. As can be appreciated, this may improve distribution of the forces across the respective engagement surfaces 134a, 134d, as compared to conventional driver keys, which in turn may reduce or inhibit potential damage to the driver key 124 and/or the wheel rim 102 often caused by the forces.

In addition, the orientation of each of the engagement surfaces 134a-d of the driver key 124 at the angle 152 operates to redirect the forces from the respective bead seat band 120 and the rim base 106 (as received through the contact surfaces 140a-d of the pockets 126, 128) in directions inwardly of the driver key body 132 and divergent from a direction of the longitudinal axis A-A′ of the driver key 124. As shown in FIG. 10, for example, when the wheel rim 102 rotates counter-clockwise (as viewed in FIG. 1), forces 165 from the contact surfaces 140a, 140d of the pockets 126, 128 may be redirected by the engagement surfaces 134a, 134d toward a centroid 166 (or center of mass) of the body 132. For example, the forces 165 are redirected in directions that are askew from (and not parallel to) the longitudinal axis A-A′ and that are inward toward the centroid 166 of the body 132. The redirected forces 165 may generate a relatively small force couple 168 at the body 132, as compared to input forces in conventional cross-shaped driver keys. In addition, the force couple 168 may be generated in the same direction as rotation of the wheel rim 102 (i.e., counter-clockwise in this example), although this is not required in all embodiments.

In conventional cross-shaped driver keys, having rectangular-shaped bodies and engagement surfaces oriented at angles of ninety degrees relative to longitudinal axes of the driver keys, the engagement surfaces do not redirect forces. Instead, the forces are maintained in directions that are parallel to the longitudinal axes of the driver keys. Consequently, substantially large force couples are generated at the driver keys because the forces are directed inwardly by the engagement surfaces along lines that are further away from centroids of the driver keys. As such, the driver keys rely on arms to resist or counteract the large force couples. In contrast, the driver key 124 of the present disclosure uniquely reduces the force couple 168 generated by the forces 165 by redirecting the forces. Thus, conventional arms may not be required to counteract the force couple 168. The smaller force couple 168 generated at the driver key 124 may also result in less damage to the driver key 124 and/or wheel rim 102 during use.

Further, the increased thickness of the upper portion of the driver key 124 operates to stabilize the driver key 124 in the upper pocket 126 during use of the wheel rim 102. This may reduce rotation of the driver key 124 in a direction, for example, transverse to longitudinal axis A-A′ (and to axis D-D′) at the driver key 124. As a result, the driver key 124 may be less likely to misalign with the pockets 126, 128 during use with the wheel rim 102.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that exemplary embodiments may be embodied in many different forms, and that neither should be construed to limit the scope of the disclosure. In some exemplary embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. In addition, the disclosure herein of particular values is not exclusive of other values that may be useful in one or more of the examples disclosed herein. Moreover, it is envisioned that any two particular values for a specific parameter stated herein may define the endpoints of a range of values that may be suitable for the given parameter (i.e., the disclosure of a first possible value and a second possible value for a given parameter can be interpreted as disclosing that any value between the first and second values could also be employed for the given parameter). For example, if parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “has,” “have,” and “having,” for example, are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance It is also to be understood that additional or alternative operations may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (e.g., with some approach to exactness in the value, approximately or reasonably close to the value, nearly, etc.). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the exemplary embodiments.

Spatially relative terms, such as “inner,” “outer,” “beneath,” “below,” “lower,” “above,” “upper,” “left,”, “right” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated ninety degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A driver key for coupling a rim base and a bead seat band of a wheel rim together, the driver key comprising a body having a first engagement surface and a second engagement surface, the first and second engagement surfaces each oriented at an angle of less than ninety degrees relative to a longitudinal axis of the body.

2. The driver key of claim 1, wherein the body is free of arms extending away from the body.

3. The driver key of claim 2, wherein:
the body further has a third engagement surface and a fourth engagement surface;
the first and second engagement surfaces are generally parallel, and the third and fourth engagement surfaces are generally parallel; and
the body defines a generally hexagon shape.

4. The driver key of claim 1, wherein the first engagement surface defines a thickness dimension greater than a thickness dimension of the second engagement surface, such that the body defines a variable thickness.

5. The driver key of claim 4, wherein:
the thickness dimension of the first engagement surface is a first thickness dimension; and
the first engagement surface further defines a second thickness dimension less than the first thickness dimension and about equal to the thickness dimension of the second engagement surface.

6. The driver key of claim 1, wherein the first and second engagement surfaces are configured to redirect forces from the bead seat band and the rim base, respectively, in directions inwardly of the body and divergent from a direction of the longitudinal axis of the body.

7. A driver key assembly comprising the driver key of claim 1, and further comprising:
a first pocket for association with the bead seat band of the wheel rim and configured to receive the first engagement surface of the driver key body, the first pocket having a contact surface that engages the first engagement surface during use of the wheel rim; and
a second pocket for association with the rim base of the wheel rim and configured to receive the second engagement surface of the driver key body, the second pocket having a contact surface that engages the second engagement surface during use of the wheel rim.

8. The driver key assembly of claim 7, wherein the contact surfaces of the first and second pockets are each oriented at an angle that complements the angle of orientation of the first and second engagement surfaces of the driver key body.

9. The driver key of claim 1, wherein the body is free of interior angles.

10. A wheel rim assembly for mounting a tire on a vehicle, the wheel rim assembly comprising:
a rim base;
a bead seat band; and
a driver key assembly, comprising:
a first pocket coupled to the bead seat band;
a second pocket coupled to the rim base; and
a driver key having first and second portions configured to be positioned at least partly within the first and second pockets, respectively, to thereby couple the bead seat band and the rim base together, the first portion defining a first thickness dimension and the second portion defining a second thickness dimension less than the first thickness dimension such that the driver key defines a variable thickness between the first and second portions.

11. The wheel rim assembly of claim 10, wherein the driver key defines first and second surfaces configured to align with the first and second pockets, respectively, when the driver key is positioned at least partly within the first and second pockets, the first and second surfaces configured to redirect input forces from the first and second pockets during use of the wheel rim assembly, to generate a force couple at the driver key in a direction that is the same as a direction of rotation of the wheel rim assembly.

12. The wheel rim assembly of claim 10, wherein the driver key defines first and second surfaces configured to align with the first and second pockets, respectively, when the driver key is positioned at least partly within the first and second pockets, the first and second surfaces each oriented at an angle of less than ninety degrees relative to a longitudinal axis of the driver key.

13. The wheel rim assembly of claim 12, wherein:
the first pocket defines a first contact surface and the second pocket defines a second contact surface, the first and second surfaces of the driver key configured to align with the first and second contact surfaces of the first and second pockets, respectively, when the driver key is positioned at least partly within the first and second pockets; and
the first and second contact surfaces are each oriented at an angle that complements the angle of the first and second surfaces of the driver key.

14. The wheel rim assembly of claim 12, wherein the driver key is free of arms extending away from the driver key in a direction longitudinally of the driver key.

15. The wheel rim assembly of claim 14, wherein:
the first surface of the driver key is configured to redirect a force from the first pocket toward a center of mass of the driver key;
the second surface of the driver key is configured to redirect a force from the second pocket toward the center of mass of the driver key; and
the longitudinal axis of the driver key extends through the center of mass of the driver key.

16. The wheel rim assembly of claim 10, wherein:
the driver key defines first and second surfaces configured to align with the first and second pockets, respectively, when the driver key is positioned at least partly within the first and second pockets;
the first surface of the driver key is configured to redirect a force from the first pocket in a direction inwardly of the driver key and divergent from a direction of a longitudinal axis of the driver key; and
the second surface of the driver key is configured to redirect a force from the second pocket in a direction inwardly of the driver key and divergent from the direction of the longitudinal axis of the driver key.

17. A method comprising providing a driver key for coupling a rim base and a bead seat band of a wheel rim together, wherein the driver key includes first and second engagement portions on a body of the driver key that are each oriented at an angle of less than ninety degrees relative to a longitudinal axis of the body.

18. The method of claim 17, wherein:
providing the driver key includes forming the first and second engagement portions on the body of the driver key; and
the method further comprises forming the body of the driver key to be free of interior angles and free of arms extending away from the body.

19. The method of claim 17, further comprising forming contact portions on first and second pockets associated with the bead seat band and the rim base, respectively, wherein the contact portions are at angles that complement the angles of the first and second engagement portions of the driver key body such that, when the driver key is received at least partly within the first and second pockets, the first engagement portion of the driver key body generally mates with the contact portion of the first pocket and the second engagement portion of the driver key body generally mates with the contact portion of the second pocket.

20. The method of claim 17, further comprising positioning the driver key at least partly within first and second pockets associated with the bead seat band and the rim base to couple the rim base and the bead seat band together.
